(19) United States
(12) Patent Application Publication
(10) Pub. No.: US 2025/0229624 A1
(43) Pub. Date: Jul. 17, 2025

(54) SUPPORTING DEVICE FOR ENGINE PERIPHERAL STRUCTURE

(71) Applicants: TOYOTA JIDOSHA KABUSHIKI KAISHA, Toyota-shi (JP); Sumitomo Riko Company Limited, Komaki-shi (JP)

(72) Inventors: Shinji Komura, Toyota-shi (JP); Yuji Okuyama, Nagakute-shi (JP); Tatsunori Taniguchi, Komaki-shi (JP); Takayuki Goto, Komaki-shi (JP); Yuto Watanabe, Komaki-shi (JP); Seiji Kasai, Komaki-shi (JP)

(73) Assignees: TOYOTA JIDOSHA KABUSHIKI KAISHA, Toyota-shi (JP); Sumitomo Riko Company Limited, Komaki-shi (JP)

(21) Appl. No.: 18/979,816

(22) Filed: Dec. 13, 2024

(30) Foreign Application Priority Data
Jan. 17, 2024 (JP) 2024-005162

(51) Int. Cl. B60K 13/04

(52) U.S. Cl. CPC B60K 13/04

(57) ABSTRACT

A lower-side support rod is attached to an exhaust pipe that is an example of a structure at the periphery of an engine. A support rubber is an elastic body, is an electric conductor, and is connected to the lower-side support rod. An upper-side support rod is connected to the support rubber and a vehicle body, and is grounded to the vehicle body. The exhaust pipe is supported by the vehicle body, through the lower-side support rod, the support rubber, and the upper-side support rod. Further, a grounding path is formed by the lower-side support rod, the support rubber, and the upper-side support rod.

### CROSS-REFERENCE TO RELATED APPLICATION

This application claims priority to Japanese Patent Application No. 2024-005162 filed on Jan. 17, 2024. The disclosure of the above-identified application, including the specification, drawings, and claims, is incorporated by reference herein in its entirety.

### BACKGROUND

### 1. Technical Field

The present disclosure relates to a device through which a structure at the periphery of an engine is supported by a vehicle body.

### 2. Description of Related Art

Japanese Unexamined Patent Application Publication No. 2016-125400 (JP 2016-125400 A) describes an exhaust device in which an exhaust system component of an engine is supported by a vehicle body through a non-conductive supporting member. Further, JP 2016-125400 A describes that the charge amount of the exhaust system component is decreased by providing a self-discharge electricity eliminator at the supporting member and thereby the output of the engine is enhanced.

### SUMMARY

In the exhaust device described in JP 2016-125400 A, the supporting member is constituted by an electric insulator, and therefore, the supporting member is easily charged. When the supporting member is charged, the sensitivity of a sensor (for example, an exhaust air sensor) that is provided at the periphery of the engine sometimes decreases. Further, the traveling performance of a vehicle sometimes decreases due to the decrease in the sensitivity of the sensor.

An object of the present disclosure is to restrain the charging of a structure at the periphery of the engine, in a supporting device through which the structure at the periphery of the engine is supported by the vehicle body.

An aspect of the present disclosure is a supporting device for an engine peripheral structure, the supporting device including: a first suspension member that is attached to the engine peripheral structure; a supporting member that is connected to the first suspension member, the supporting member being an elastic body and being an electric conductor; and a second suspension member that is connected to the supporting member and a vehicle body, the second suspension member being grounded to the vehicle body, in which the engine peripheral structure is supported by the vehicle body, through the first suspension member, the supporting member, and the second suspension member.

In the present disclosure, it is possible to restrain the charging of the structure at the periphery of the engine, in the supporting device through which the structure at the periphery of the engine is supported by the vehicle body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a supporting device according to an embodiment;

FIG. 2 is a plan view showing a support rubber;

FIG. 3 is a schematic view showing a supporting device according to a modification;

FIG. 4 is a graph showing temporal changes in an output value of an exhaust air sensor; and

FIG. 5 is a graph showing temporal changes in a front-rear acceleration of a vehicle.

### DETAILED DESCRIPTION OF EMBODIMENTS

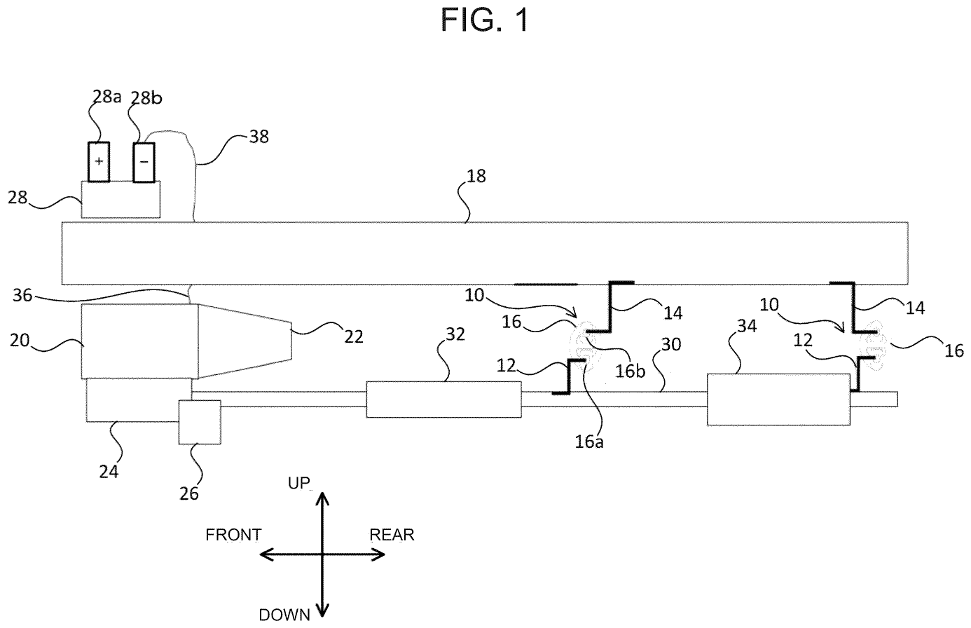

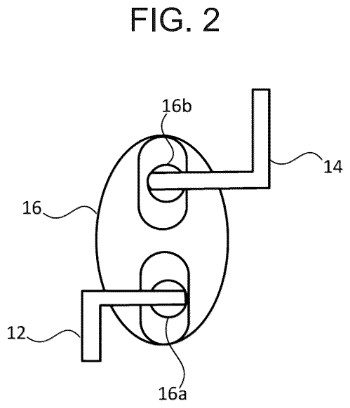

A supporting device 10 according to an embodiment will be described with reference to FIG. 1 and FIG. 2. FIG. 1 is a schematic view of a supporting device 10, and is a diagram showing a lower structure of a vehicle body 18. FIG. 2 is a plan view showing a support rubber 16.

An engine 20, a transmission 22, an exhaust manifold 24, and an exhaust air sensor 26 are attached to a lower side of the vehicle body 18 at a front portion of a vehicle. For example, the exhaust air sensor 26 is an A/F sensor (air-fuel ratio sensor). A battery 28 for auxiliary machines is provided at the front portion of the vehicle.

Further, an exhaust pipe 30, a sub-muffler 32, and a main-muffler 34 are provided, at a lower portion of the vehicle body 18. A distal end of the exhaust pipe 30 is attached to the exhaust manifold 24. The exhaust pipe 30 is provided from the front portion of the vehicle to a rear portion of the vehicle. The main-muffler 34 is attached to the exhaust pipe 30 on a rear portion side of the vehicle. The sub-muffler 32 is attached to the exhaust pipe 30 at a position between the exhaust manifold 24 and the main-muffler 34.

The exhaust pipe 30, the sub-muffler 32, and the main-muffler 34 are examples of the exhaust system component of the engine 20, and correspond to an example of the structure at the periphery of the engine 20.

The exhaust gas emitted from the engine 20 is sent to the exhaust pipe 30 through the exhaust manifold 24. The exhaust gas is serially sent to the sub-muffler 32 and the main-muffler 34 through the exhaust pipe 30, and thereafter, is sent rearward of the vehicle, to be emitted in the atmosphere.

Through the supporting device 10, the structure at the periphery of the engine 20 is supported by the vehicle body 18 on the lower side of the vehicle body 18. Specifically, through the supporting device 10, the exhaust pipe 30 is supported by the vehicle body 18 in a vibration-proof manner, and thereby, the vibration of the engine 20 is prevented from being transmitted to the vehicle body 18.

As shown in FIG. 1 and FIG. 2, the supporting device 10 includes a lower-side support rod 12, an upper-side support rod 14, and a support rubber 16. In the example shown in FIG. 1, two supporting devices 10 are provided. However, one supporting device 10 may be provided, or three or more supporting devices 10 may be provided. The lower-side support rod 12 corresponds to an example of the first suspension member, the upper-side support rod 14 corresponds to an example of the second suspension member, and the support rubber 16 corresponds to an example of the supporting member.

The lower-side support rod 12 is a bracket made of metal. For example, a lower end portion of the lower-side support rod 12 is fixed to the exhaust pipe 30 by a fastening member such as a bolt, and thereby, the lower-side support rod 12 is attached to the exhaust pipe 30. An upper end portion of the lower-side support rod 12 is connected to the support rubber 16.

The upper-side support rod 14 is a bracket made of metal. For example, an upper end portion of the upper-side support rod 14 is fixed to a lower surface of the vehicle body 18 by a fastening member such as a bolt, and thereby, the upper-side support rod 14 is attached to the vehicle body 18. The upper-side support rod 14 may be a member that is integrated with the vehicle body 18. A lower end portion of the upper-side support rod 14 is connected to the support rubber 16.

The support rubber 16 is an elastic body and is an electric conductor (for example, the volume resistivity is about 10000 Q·cm). For example, the support rubber 16 is a conductive NBR (acrylonitrile butadiene rubber), or EPDM (ethylene propylene diene rubber). The above-described materials are just examples, and another material may be used for the support rubber 16.

An upper portion of the support rubber 16 is supported by the vehicle body 18 through the upper-side support rod 14. A lower portion of the support rubber 16 is connected to the exhaust pipe 30 through the lower-side support rod 12. Thereby, the exhaust pipe 30, the sub-muffler 32, and the main-muffler 34 are supported by the vehicle body 18 through the support rubber 16.

As shown in FIG. 2, through-holes 16a, 16b are formed on the support rubber 16. The through-hole 16a is a hole that passes through the support rubber 16 at the lower portion of the support rubber 16. The through-hole 16b is a hole that passes through the support rubber 16 at the upper portion of the support rubber 16.

The upper end portion of the lower-side support rod 12 is inserted into the through-hole 16a of the support rubber 16. Thereby, the lower-side support rod 12 and the support rubber 16 are connected to each other. Further, the lower end portion of the upper-side support rod 14 is inserted into the through-hole 16b of the support rubber 16. Thereby, the upper-side support rod 14 and the support rubber 16 are connected to each other.

The support rubber 16 is hung from the vehicle body 18 through the upper-side support rod 14, and the lower-side support rod 12 is hung from the support rubber 16. That is, the lower-side support rod 12, the support rubber 16, and the upper-side support rod 14 are suspended from the vehicle body 18 to the exhaust pipe 30. Thereby, the exhaust pipe 30, the sub-muffler 32, and the main-muffler 34 are supported by the vehicle body 18, through the lower-side support rod 12, the upper-side support rod 14, and the support rubber 16.

The engine 20 is grounded to the vehicle body 18 by a grounding wire 36. The battery 28 includes a positive electrode 28a and a negative electrode 28b. The negative electrode 28b is connected to the vehicle body 18 by a grounding wire 38. Thereby, the battery 28 is grounded to the vehicle body 18.

The lower-side support rod 12 and the upper-side support rod 14 are composed of metal, and the support rubber 16 is constituted by an electric conductor. Therefore, a grounding path is formed from the exhaust pipe 30 to the vehicle body 18, through the lower-side support rod 12, the support rubber 16, and the upper-side support rod 14.

In the case where a plurality of supporting devices 10 is used, the above grounding path is formed when the support rubber 16 of at least one supporting device 10 of the plurality of supporting devices 10 is an electric conductor. Therefore, the support rubbers 16 of the other supporting devices 10 may be electric insulators.

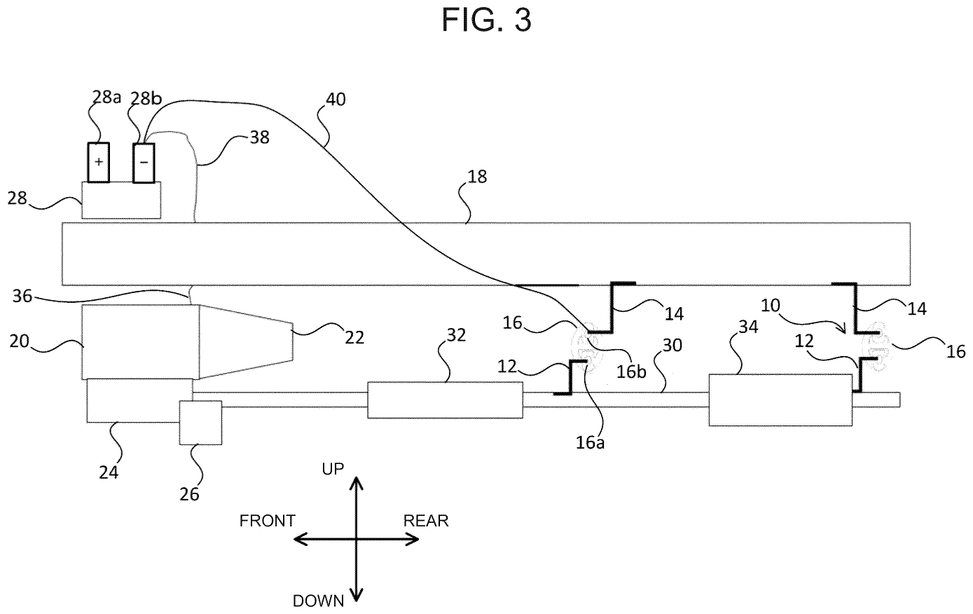

As in the case of a modification shown in FIG. 3, the support rubber 16 may be connected to the negative electrode 28b of the battery 28 by a grounding wire 40, and thereby, a direct grounding path may be formed. In this case, the upper-side support rod 14 may be composed of a material other than metal.

When the vehicle travels, each portion of tires repeatedly gets contact with and departs from a road surface, and thereby, static electricity is sometimes generated. Further, constituent components of the engine 20 and constituent components of a brake device perform relative motion, and thereby, static electricity is sometimes generated.

In the embodiment, the grounding path is formed from the exhaust pipe 30 to the vehicle body 18, by the supporting device 10, and therefore, it is possible to restrain the charging of the structure at the periphery of the engine 20. As a result, it is possible to restrain the decrease in the sensitivity of a sensor (for example, the exhaust air sensor 26) that is provided at the periphery of the engine 20, and to restrain the decrease in the traveling performance of the vehicle.

As described above, in order that the exhaust pipe 30 is supported by the vehicle body 18 in a vibration-proof manner, it is necessary to use a support rubber that is an elastic body. If all support rubbers are electric insulators, the exhaust pipe 30 is equipped in the vehicle in an electrically insulated state. As a result, the structure at the periphery of the engine 20 can be charged, and the sensitivity of the sensor can decrease. For coping with this, it is possible that the grounding path is formed by winding an aluminum tape around the support rubber. However, it is difficult to continue to hold the aluminum tape around the support rubber in a harsh vehicle use environment, and therefore, the use of the aluminum tape is impractical. In contrast, in the embodiment, without impairing the function of the support rubber 16 through which the exhaust pipe 30 is supported by the vehicle body 18 in a vibration-proof manner, it is possible to form the grounding path that includes the support rubber 16. As a result, it is possible to restrain the decrease in the sensitivity of the sensor. Further, the charging of the interior of the exhaust pipe 30 is restrained, and

thereby, it is possible to reduce the disturbance of the flow of the exhaust gas that flows through the exhaust pipe 30. As a result, it is possible to reduce the back pressure in the exhaust pipe 30. Furthermore, the charging of the outside of the exhaust pipe 30 is restrained, and therefore, it is possible to reduce the disturbance of the air under a floor of the vehicle. As a result, it is possible to reduce the traveling resistance of the vehicle.

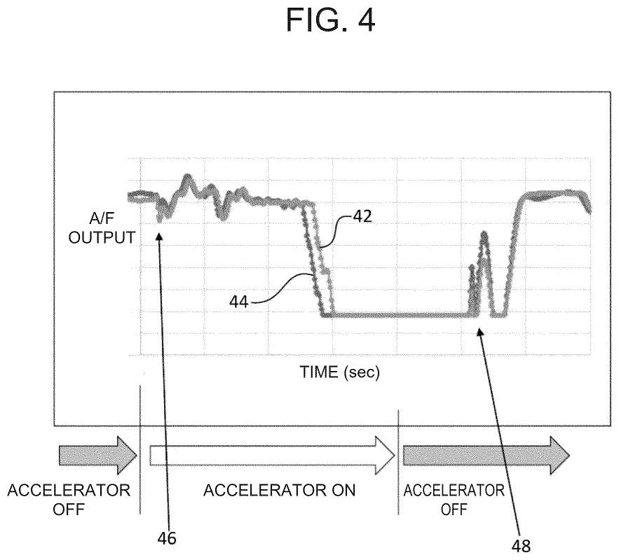

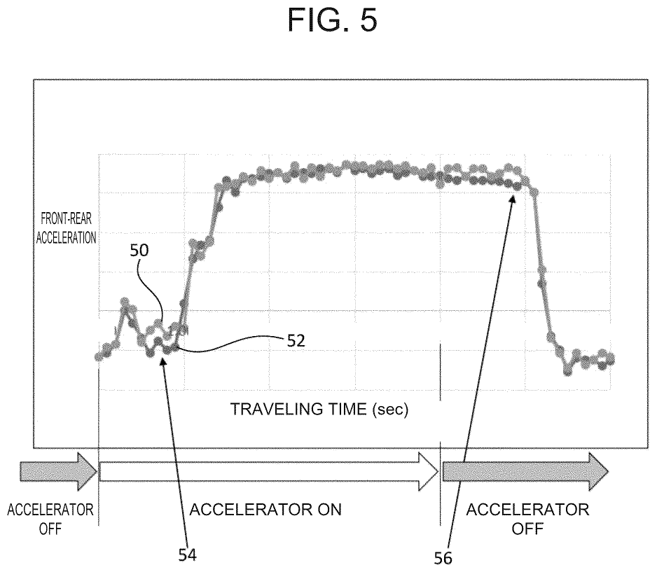

Effects of the supporting device 10 will be described below with reference to FIG. 4 and FIG. 5. FIG. 4 shows temporal changes in an output value of the exhaust air sensor 26. FIG. 5 shows temporal changes in a front-rear acceleration of the vehicle.

In FIG. 4, the abscissa axis indicates time, and the ordinate axis indicates the output value of the exhaust air sensor 26. A graph 42 shows a temporal change in the output value in the case where the supporting device 10 is used. A graph 44 shows a temporal change in the output value in the case where a supporting device according to a comparative example is used. In the supporting device according to the comparative example, the support rubber is constituted by an electric insulator.

As indicated by reference numeral 46, in the embodiment, the response of the exhaust air sensor 26 after an accelerator is switched from an OFF state to an ON state is faster than the response in the comparative example, and the responsivity is high. Further, as indicated by reference numeral 48, the noise of the output value after the accelerator is switched to the OFF state is smaller than the noise of the output value in the comparative example. In this way, the embodiment improves the responsivity of the exhaust air sensor 26, and reduces the noise of the output value.

In FIG. 5, the abscissa axis indicates traveling time, and the ordinate axis indicates the front-rear acceleration of the vehicle. A graph 50 shows a temporal change in the front-rear acceleration in the case where the supporting device 10 is used. A graph 52 shows a temporal change in the front-rear acceleration in the case where the supporting device according to the comparative example is used.

As indicated by reference numeral 54, in the embodiment, the front-rear acceleration after the accelerator is switched from the OFF state to the ON state is not lower than the front-rear acceleration in the comparative example, and the rise of the front-rear acceleration is high. That is, in the embodiment, since the charging of the exhaust air sensor 26 is restrained, it is possible to increase the response speed in the control by an electronic control unit (ECU) equipped in the vehicle, so that the rise of the front-rear acceleration is high.

Further, as indicated by reference numeral 56, the decrease in the front-rear accelerator after the accelerator is switched to the OFF state is smaller than the decrease in the front-rear accelerator in the comparative example. As a result, it is possible to restrain the decrease in the traveling speed of the vehicle.

The supporting device 10 according to the embodiment may be equipped in a battery electric vehicle (BEV), a hybrid electric vehicle (HEV), a plug-in hybrid electric vehicle (PHEV), or a fuel cell electric vehicle (FCEV). For example, in the case where a motor for traveling is equipped in the vehicle, the supporting device 10 may be used as a supporting device through which a structure at the periphery of the motor is supported by the vehicle body. Thereby, it is possible to restrain the charging of the structure at the periphery of the motor.

What is claimed is:

1. A supporting device for an engine peripheral structure, the supporting device comprising:
a first suspension member that is attached to the engine peripheral structure;
a supporting member that is connected to the first suspension member, the supporting member being an elastic body and being an electric conductor; and
a second suspension member that is connected to the supporting member and a vehicle body, the second suspension member being grounded to the vehicle body, wherein
the engine peripheral structure is supported by the vehicle body, through the first suspension member, the supporting member, and the second suspension member.

2. The supporting device for the engine peripheral structure according to claim 1, wherein the second suspension member is grounded with a battery that is provided in a vehicle.
